(19) United States
(12) Patent Application Publication
(10) Pub. No.: US 2005/0146833 A1
(43) Pub. Date: Jul. 7, 2005

(54) Methods and apparatus for a disposable grounding device

(76) Inventors: Brent Beamer, Cary, NC (US); Lawrence Dale Lewis, Sanford, NC (US)

Correspondence Address: WILLIAM L. LONDON, 3010 LEE AVENUE, P.O. BOX 152, SANFORD, NC, 27330, US

(21) Appl. No.: 10/751,753

(22) Filed: Jan. 5, 2004

(51) Int. Cl. H02H 1/00

(52) U.S. Cl. 361/212

(57) ABSTRACT

A disposable grounding strap is provided. The disposable grounding strap includes an elongate conductive material uniformly conductive along its length. A first outer layer is coated with non-conductive heat sealable plastic on a side disposed adjacent to a first side of the conductive material, with the first outer layer having a width greater than the width of the conductive material. A second outer layer is coated with non-conductive heat sealable plastic on a side disposed adjacent to a second side of the conductive material, with the second outer layer having a width greater than the width of the conductive material. The non-conductive heat sealable plastic of the second outer layer is partially heat sealed to the non-conductive heat sealable plastic of the first outer layer along at least a portion of the length of the conductive material.

### BACKGROUND

The present invention relates to electrostatic discharge devices, and more particularly to a disposable grounding device for preventing the buildup of excess electrostatic charge.

When sensitive electronic parts are handled or touched by an individual, the sudden discharge of electrostatic charge from the individual can damage or destroy these components. Grounding straps are used in the electronic industry to insure that workers are at the same electrical potential as ground, and thus prevent the buildup of excess electrostatic charge that can harm electronic components. Grounding straps operate by establishing an electrical pathway that is electrically connected from an individual's wrist or other body part to electrical ground. This electrical pathway must be sufficiently electrically conductive to maintain the person at the same electrical potential as ground, while not so electrically conductive as to endanger any person who may come in contact with a charged source. An electrical pathway with a resistance of between 750 kilohms to 10 megohms is typically preferred.

There are numerous wrist straps that provide an electrical pathway coupled with a discrete resistance in the desired range. These wrist straps are typically intended for reuse over and over again. More recently disposable wrist straps have come into being. These wrist straps involve the use of relatively low cost material that is designed to be used once, and then thrown away. Users find this more convenient. Prior art disposal wrist straps may use a conductive plastic material attached to another material. As this conductive plastic material may have a resistance less than the desired range, the conductive plastic may be cut or slit in a number of locations to create a longer, narrower, more convoluted pathway from the individual to ground through the conductive plastic strip. This more convoluted pathway increases the resistance to the desired range. Alternatively, the thickness of the conductive plastic for a given location may be constricted, thus also increasing resistance of the conductive plastic.

Another prior art strap uses a conductive plastic material having an electrically interrupted segment, with the interrupted segment being bridged by a resistor of the desired resistance.

One difficulty with these techniques is that they involve more expensive manufacturing steps. For example, the techniques of slitting the material to create the more convoluted electrical path and incorporating a separate resistor add to the cost of the disposable wrist straps. As cost is a key factor in the manufacturing of a disposable product, the elimination of either of these steps is to be desired.

### SUMMARY

In accordance with an embodiment of the present invention, a disposable grounding strap is provided. The disposable grounding strap includes an elongate conductive material uniformly conductive along its length. A first outer layer is coated with non-conductive heat sealable plastic on a side disposed adjacent to a first side of the conductive material, with the first outer layer having a width greater than the width of the conductive material. A second outer layer is coated with non-conductive heat sealable plastic on a side disposed adjacent to a second side of the conductive material, with the second outer layer having a width greater than the width of the conductive material. The heat sealable plastic of the second outer layer is partially heat sealed to the heat sealable plastic of the first outer layer along at least a portion of the length of the conductive material.

A more complete understanding of the present invention, as well as further features and advantages of the invention, will be apparent from the following detailed description and the accompanying drawings.

### BRIEF DESCRIPTION OF THE DRAWINGS

FIG. 1 shows a perspective view of a disposable wrist strap in accordance with the present invention;

FIG. 2 shows a perspective view of a disposable wrist strap connected between an individual and electrical ground in accordance with the present invention;

FIG. 3 shows a cross-sectional view of a disposable wrist strap in accordance with the present invention;

FIG. 4 shows a perspective view of one end of a disposable wrist strap; and

FIG. 5 shows an alternate embodiment of a disposable wrist strap in accordance with the present invention.

### DETAILED DESCRIPTION

The following detailed description of preferred embodiments refers to the accompanying drawings which illustrate specific embodiments of the invention. Other embodiments having different structures and operations do not depart from the scope of the present invention.

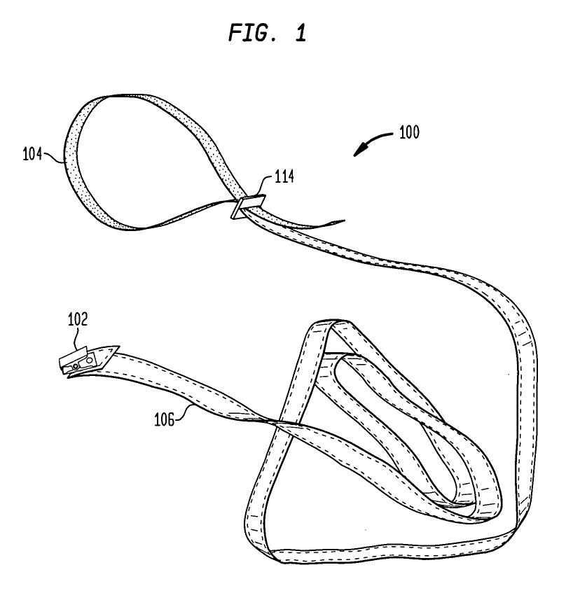

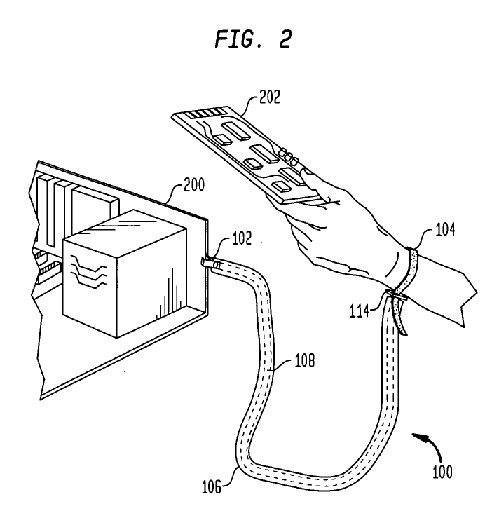

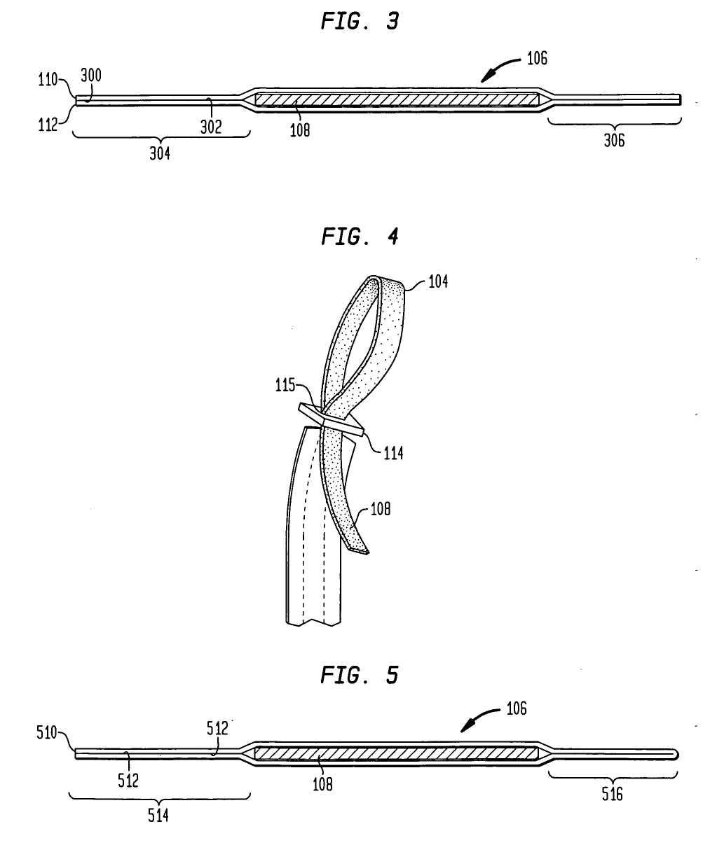

FIGS. 1 and 2 show a disposable wrist strap 100 in accordance with the present invention. The disposable wrist strap 100 includes a flat strip 106 having a conductive attachment device 102 at a ground contacting end and a wrist loop 104 at a body contacting end. As described in greater detail below and shown more clearly in FIG. 3, the strip 106 includes a uniformly conductive layer 108 sandwiched between outer layers 110 and 112. To maintain electrical continuity with the wrist loop 104, the attachment device 102 is mechanically attached to the uniformly conductive layer 108. While in a preferred embodiment the attachment device 102 comprises a metal clip, other devices, such as a conductive button, a conductive snap, and the like, may be used to attach the uniformly conductive layer 108 to electrical ground. As best seen in FIG. 4, the wrist loop 104 comprises a length of the uniformly conductive material looped around and secured by a holding member 114. The holding member 114 allows the wrist loop 104 to be tightened and secured to a user's wrist. While in a preferred embodiment the holding member 114 comprises an injection molded plastic buckle with a slot 115 through which the uniformly conductive layer 108 is looped, other devices such as an O-ring or other plastic clips may be used to secure the wrist loop 104 in a loop shape around an individual's wrist.

FIG. 2 shows an exemplary application of the disposable wrist strap 100 in accordance with the present invention. The attachment device 102 is clipped to the frame 200 of an electronic device (or ground), and the wrist loop 104 is looped around and tightened against the user's wrist. Thus, the user is electrically grounded and can now safely install an electronic component, such as adapter card 202, in the electronic device.

In a preferred embodiment, the uniformly conductive layer 108 is a paper material that has been carbon loaded to provide uniform conductivity throughout its length (BONTEX Inc., Buena Vista Va.). Uniform conductivity simply means that any given section of the conductive layer 108 will have substantially the same resistance as any other section of the conductive layer 108 of the same dimensions. The length of the paper material and the degree of carbon loading may be suitably selected so as to provide a desired degree of resistance from the attachment device 102 to the wrist loop 104. This conductivity is preferably between 700 kilohms and 2.0 megohms.

As shown in FIG. 3, the conductive material 108 is covered by outer layers 110 and 112, which, in a preferred embodiment, are paper or other suitable material. The outer layers 110 and 112 are wider than the conductive layer 108 and extend over the length of the conductive material 108, but do not cover the wrist loop 104, allowing the conductive material of the wrist loop 104 to contact a individual's body. Outer layer 110 may include a layer of non-conductive heat sealable plastic 300 on the side of the layer 110 which is in contact with the conductive material 108. Similarly, outer layer 112 may include a layer of non-conductive heat sealable plastic 302 on the side of layer 112 which is in contact with the conductive material 108. The layers of non-conductive heat sealable plastic 300 and 302 may suitably comprise polyethylene. To secure the outer layer 110 to the outer layer 112, the layers of non-conductive heat sealable plastic 300 and 302 may be heat sealed to each other along edges 304 and 306 using a laminating machine.

In another aspect of the present invention, as seen in FIG. 5, a single outer layer 510 may be folded and used to cover the conductive material 108. The outer layer 510 includes a layer of non-conductive heat sealable plastic 512 on a side which is in contact with the conductive material 108. The outer layer 510 may be secured by heat sealing along edges 514 and 516.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A disposable grounding strap comprising:
an elongate conductive material uniformly conductive along its length;
a first outer layer coated with non-conductive heat sealable plastic on a side disposed adjacent to a first side of the conductive material, said first outer layer having a width greater than the width of the conductive material; and
a second outer layer coated with non-conductive heat sealable plastic on a side disposed adjacent to a second side of the conductive material, said second outer layer having a width greater than the width of the conductive material, said non-conductive heat sealable plastic of the second outer layer partially heat sealed to the non-conductive heat sealable plastic of the first outer layer along at least a portion of the length of the conductive material.

2. The disposable grounding strap of claim 1 further comprising:
a conductive attachment device electrically connected to a first end of the elongate conductive material.

3. The disposable grounding strap of claim 2 further comprising:
a wrist loop formed from a length of the elongate conductive material at a second end of the elongate conduct, said length of elongate conductive material forming the wrist loop not covered by the first and second outer layers; and
a holding member including a slot for securing the wrist loop in a loop shape.

4. The disposable grounding strap of claim 3 wherein the holding member comprises an injection molded plastic buckle.

5. The disposable grounding strap of claim 1 wherein the elongate conductive material is a carbon loaded paper material.

6. The disposable grounding strap of claim 1 wherein the non-conductive heat sealable plastic comprises polyethylene.

7. The disposable grounding strap of claim 1 wherein the resistance of the elongate conductive material along its length is between 700,000 ohms and 2,000,000 ohms.

8. The disposable grounding strap of claim 1 wherein the first and second outer layers comprise paper.

9. A method of forming a disposable grounding strap comprising:
providing an elongate conductive material uniformly conductive along its length;
providing a first outer layer coated with non-conductive heat sealable plastic on a coated side, said first outer layer having a width greater than the width of the conductive material;
providing a second outer layer coated with non-conductive heat sealable plastic on a coated side, said second outer layer having a width greater than the width of the conductive material;
placing the elongate conductive material between the first outer layer and the second outer layer such that the elongate conductive material is in contact with the coated side of the first outer layer and the coated side of the second outer layer; and
heat sealing the non-conductive heat sealable plastic of the second outer layer to the non-conductive heat sealable plastic of the first outer layer along at least a portion of the length of the conductive material.

10. The method of claim 9 further comprising:
attaching a conductive attachment device a first end of the elongate conductive material.

11. The method of claim 10 further comprising:
forming a wrist loop from a length of the elongate conductive material at a second end of the elongate conduct, said length of elongate conductive material forming the wrist loop not covered by the first and second outer layers; and
attaching a holding member including a slot to the wrist loop for securing the wrist loop.

12. The method of claim 11 wherein the holding member comprises an injection molded plastic buckle.

13. The method of claim 9 wherein the elongate conductive material is a carbon loaded paper material.

14. The method of claim 9 wherein the non-conductive heat sealable plastic comprises polyethylene.

15. The method of claim 9 wherein disposable grounding strap of claim 1 wherein the resistance of the elongate conductive material along its length is between 700,000 ohms and 2,000,000 ohms.

16. The method of claim 9 wherein the first and second outer layers comprise paper.

17. A disposable grounding strap comprising:
an elongate conductive material uniformly conductive along its length;
an outer layer coated with non-conductive heat sealable plastic on a side disposed adjacent to both a first side of the conductive material and a second side of the conductive material, said outer layer having a width greater than twice the width of the conductive material, a first portion of the non-conductive heat sealable plastic partially heat sealed to a second portion of the non-conductive heat sealable plastic along at least a portion of the length of the conductive material.
